(19) United States
(12) Patent Application Publication
(10) Pub. No.: US 2004/0232378 A1
(43) Pub. Date: Nov. 25, 2004

(54) Electro-rheological fluid comprising polyaniline-clay nanocomposite

(75) Inventors: Moon-Suk Suh, Daejeon (KR); Min-Jae Shin, Daejeon (KR); Kyo-Jun Choi, Daejeon (KR); In-Sik Han, Daejeon (KR); Sun-Kyu Jeong, Daejeon (KR); Hyoung Jin Choi, Seoul (KR); Ji Woo Kim, Incheon (KR)

Correspondence Address: SCULLY SCOTT MURPHY & PRESSER, PC, 400 GARDEN CITY PLAZA, GARDEN CITY, NY, 11530

(73) Assignee: Agency for Defense Development, Daejeon (KR)

(21) Appl. No.: 10/442,205

(22) Filed: May 20, 2003

(51) Int. Cl. C09K 3/18

(52) U.S. Cl. 252/70

(57) ABSTRACT

The present invention provides an electro-rheological fluid based on an organic and inorganic nanocomposite, that is, polyaniline-Na⁺-MMT clay nanocomposite, which is in a layered structure. The polyaniline-Na⁺-MMT clay nanocomposite particles can be synthesized by an emulsion polymerization. New ER fluid comprising polyaniline-clay nanocomposite particles dispersed in a non-conductive medium shows that shear stress remains almost constant when increasing shear rate, as well as when being applied various electric fields, even in high shear region, and has a good thermal stability.

### BACKGROUND OF THE INVENTION

1. Field of the Invention

The present invention relates to an electro-rheological (hereinafter, referred to as “ER”) fluid comprising nanocomposite particles of polymer and clay, which is in a layered structure.

2. Description of the Background Art

An ER fluid exhibits reversible changes in Theological properties when an electric field is applied. ER fluid usually consists of particle suspensions with a high degree of dielectric constant mismatch between the particle and fluid. Because of the controllable rheological properties, ER fluid can potentially be used as a smart material for active devices, which transform electrical energy to mechanical energy. Since Winslow discovered ER behavior, it has been reviewed in several recent publications, and various potential materials for ER fluids have been also introduced. Among these materials, polymeric systems were frequently selected due to their advantages, such as thermal stability, low density and easiness in handing. Semiconducting polymers including poly(acene quinone) radicals, polyaniline (hereinafter, referred to as “PANI”), copolypyrrole and copolyanilines (“COPA”) have recently been adopted for anhydrous ER fluids. In particular, PANI and derivatives thereof based on oxidation state modification, dopants and polymerization conditions are of great technological interest. Furthermore, PANI can be easily prepared by an oxidation polymerization at moderately low temperature and doped with simple protonic acids to give from a conducting emeraldine hydrochloride form to an insulating state.

On the other hand, clay minerals have recently been adapted to the field of nanocomposites because of their small particle sizes and intercalation properties, especially in the application of reinforcement materials with polymers. Among various clay materials, montmorillonite (hereinafter, referred to as “MMT”) clay has been widely used for this purpose. MMT, a hydrous alumina silicate mineral whose lamellae are constructed from an octahedral alumina sheet sandwiched between two tetrahedral silica sheets, exhibits a net negative charge on the lamellar surface and causes them to attach by absorbed cation, such as Na⁺ or Ca²⁺. The emulsion system containing an aqueous medium can contribute to the maximization of the affinity between the hydrophilic host and hydrophobic guest by the action of the emulsifier.

Choi et al. have recently synthesized SAN-clay nanocomposite particles and studied ER properties thereof.

### SUMMARY OF THE INVENTION

An object of the present invention is to provide an electro-rheological fluid in which the rheological properties are improved, that is, having a property of maintaining the shear stress almost constant with increasing shear rate even in a high shear region and having a good thermal stability. The clay in the nanocomposite particle is acted as an insulating material to decrease electrical current density under an electric field.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows the schematic diagram of a synthetic process of the PANI-clay nanocomposite;

FIG. 2 presents the thermogravimetric analysis (“TGA”) results of PANI-clay nanocomposite;

FIG. 3 shows X-ray diffraction (“XRD”) analysis comparison of Na⁺-MMT, PANI and PANI-clay composite;

FIG. 4A presents shear stress vs. shear rate of PANI-clay nanocomposite suspensions (pH 10, 20 wt.%) at various electric field strengths, and FIG. 4B presents shear viscosity vs. shear rate of PANI-clay nanocomposite suspensions (PACL 15-1, PACL 15-3, PACL 30, pH 10, 20 wt.%, at 2 kV/mm);

FIG. 5A shows shear stress vs. shear rate of different PANI-clay nanocomposite suspensions (PACL 15-1, PACL 15-3, PACL 30, pH 10, 20 wt.%, at 2 kV mm), FIG. 5B shows shear viscosity vs. shear rate of different PANI-clay nanocomposite suspensions (PACL 15-1, PACL 15-3, PACL 30, pH 10, 20 wt.%, at 2 kV/mm);

FIG. 6 shows change in static yield stress with varying electric field strength (20 wt.% suspension in pH 10);

FIG. 7 shows changes in current density with varying electric field strength (20 wt.% suspension in pH 10);

FIG. 8A shows the data from the strain (amplitude) sweep with electric fields (20 wt.% suspension in pH 10)

FIG. 8B shows the data from frequency sweep with electric fields (20 wt.% suspension in pH 10).

### DETAILED DESCRIPTION OF THE PREFERRED EMBODIMENTS

Reference will now be made in detail to the preferred embodiments of the present invention, examples of which are illustrated in the accompanying drawings.

The above and other objects of the present invention can be achieved by providing an ER fluid comprising layer-structured nanocomposite particles, which are synthesized from a PANI and clay by an emulsion polymerization, dispersed in a non-conductive medium. That is, the ER fluid of the present invention comprises a non-conductive medium, layered structured clay and conductive polyaniline inserted between the layers of the layered structured clay. The ER fluid of the present invention is an anhydrous system having a good thermal stability.

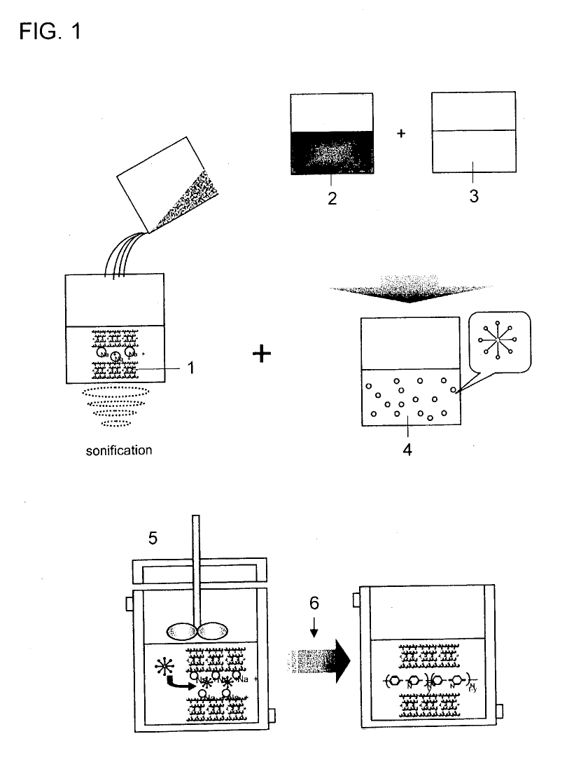

PANI-Na⁺-MMT clay nanocomposite particles used for the ER fluid of the present invention are synthesized via emulsion polymerization procedures as illustrated in FIG. 1, and then used to prepare an ER fluid by dispersing them in a non-conductive medium. The synthetic procedures of PANI-Na⁺-MMT clay nanocomposite particles and preparation of ER fluid will now be described in detail with reference to FIG. 1.

The Na⁺-MMT 1 in an aqueous medium is prepared and sonicated using an ultrasonic generator equipped with temperature controller. A solution 3 of dodecylbenzene sulfonic acid (hereinafter, referred to as “DBSA”) dissolved in distilled water is mixed with a solution 2 of aniline in xylene for about one hour while stirring. DBSA acts as an emulsifier in the mixture of the distilled water, aniline and xylene. When an emulsion is formed, the Na⁺-MMT clay 1 and emulsion solution 4 are mixed in a reactor 5 by stirring, while the temperature is kept constant at 25° C. If necessary, the reaction temperature may be varied in the range of 0-25° C. An oxidant initiator solution 6 in distilled water is then added dropwise into the reactor for one hour to initiate a desired emulsion polymerization. As an oxidant initiator, ammonium peroxysulfate (hereinafter, referred to as “APS”) may be used. After about 24 hours from the initiation of the emulsion polymerization, the reaction is terminated by introducing excess amount of acetone into the reaction mixture. The pH of the product is then adjusted to 10 by adding either 1M NaOH or HCl aqueous solution. Afterward, PANI-Na⁺-MMT clay nanocomposite particles are obtained by washing, filtering, drying, milling and sieving the product, sequentially.

The following Table 1 shows three different types of PANI-clay nanocomposite particles called as PACL 15-1, PACL 15-3 and PACL 30, respectively, which are prepared with changing the ratios of monomer to clay and/or DBSA contents.

TABLE 1

| | Input ratio of | | |
|---|---|---|---|
| | monomer to clay | DBSA content | |
| | (w/w) | (mole) | pH |
| PACL 15-1 | 1:0.15 | 0.15 | 10 |
| PACL 15-3 | 1:0.15 | 0.25 | 10 |
| PACL 30 | 1:0.30 | 0.25 | 10 |

The ER fluid of the present invention is prepared by dispersing the resultant PANI-Na⁺-MMT clay nanocomposite particles in a non-conductive medium. In the present invention, the content of the PANI-Na⁺-MMT clay nanocomposite particles may be in the range of 15-25% by weight of the ER fluid. In the most preferable embodiment of the present invention, the content of PANI-Na⁺-MMT clay nanocomposite particles in ER fluid is 20% by weight.

The non-conductive medium used for the present invention can be selected from the group consisting of silicone oil, transformer oil, transformer insulating solution, mineral oil, olive oil and mixtures thereof, but not limited thereto. The non-conductive medium preferably has a viscosity of 30 cS.

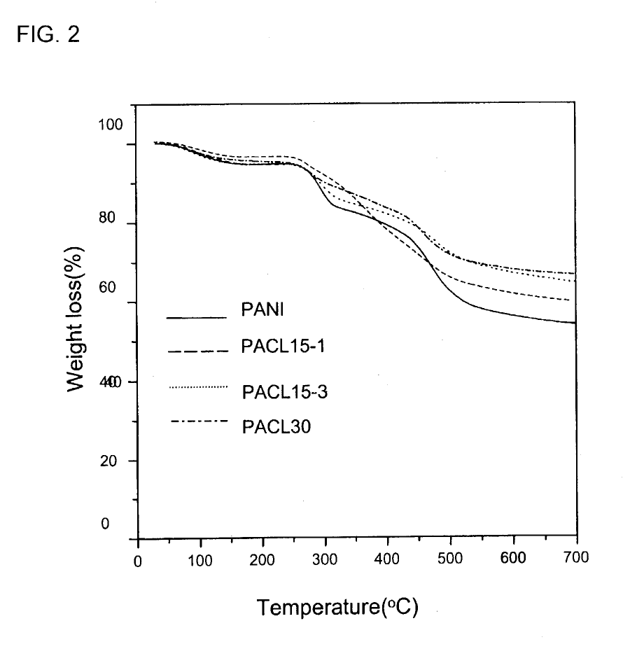

FIG. 2 explains the thermal stability of PANI-clay nanocomposite particles with TGA analysis results. As can be seen in FIG. 2, the stability of PANI-Na⁺-MMT clay nanocomposite particles was increased compared with pure PANI. That is, the PANI-clay nanocomposite particles prepared as described above has a thermal stability so that it can endure until the temperature reaches to 300° C.

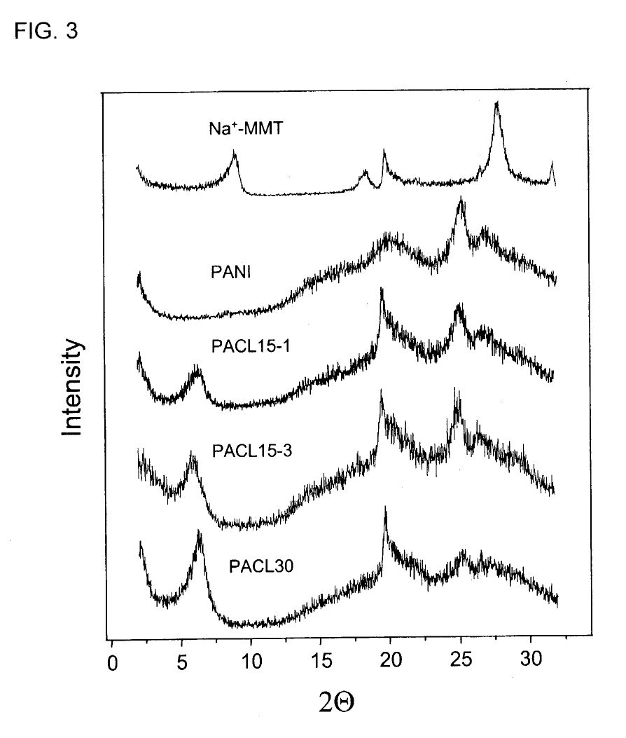

The XRD analysis results in FIG. 3 show that the interlayer spacing of the clay increases with both PANI and DBSA loading. It is discovered that the interlayer spacing increases from 9.6 Å, which is the base distance in the Na⁺-MMT clay itself, to 14.2 Å, 14.8 Å and 14.2 Å, respectively, which are the values of the PANI-clay nanocomposites, due to the insertion of the PANI between the layers of the Na⁺-MMT clay. Surely, in case of pure PANI of amorphous phase, it had no (001) peak.

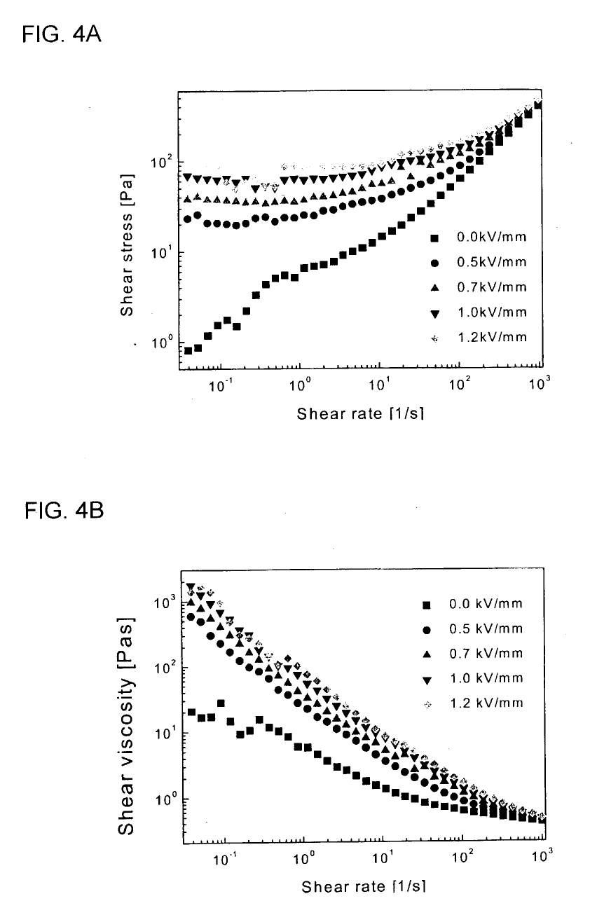

FIGS. 4A and 4B respectively show shear stress and shear viscosity curves obtained from the controlled shear rate (CSR) test for 20 wt.% suspension of PANI-clay nanocomposite called as PACL 15-3 with five different electric field strengths.

When electric field is not applied, the shear stress increases linearly with the shear rate increase. However, after electric field is applied, the shear stress is jumped up to and then maintained at a certain value until the shear rate reaches a “critical shear rate”, while the shear viscosity decreases with shear rate. The decrease of shear viscosity is larger with electrical field increase that shows general shear thinning behavior. Because of the high volume fraction of nanocomposite particles in the ER fluid, non-Newtonian behavior with a slope less than 1 is observed even with no applied electric field. Furthermore, a “critical shear rate” for pseudo-Newtonian behavior has been observed in the high shear rate region. Herein, the term “critical shear rate” means a critical point in which a shear stress increases again after decrease or maintenance so that the fluid exhibits Newtonian behavior.

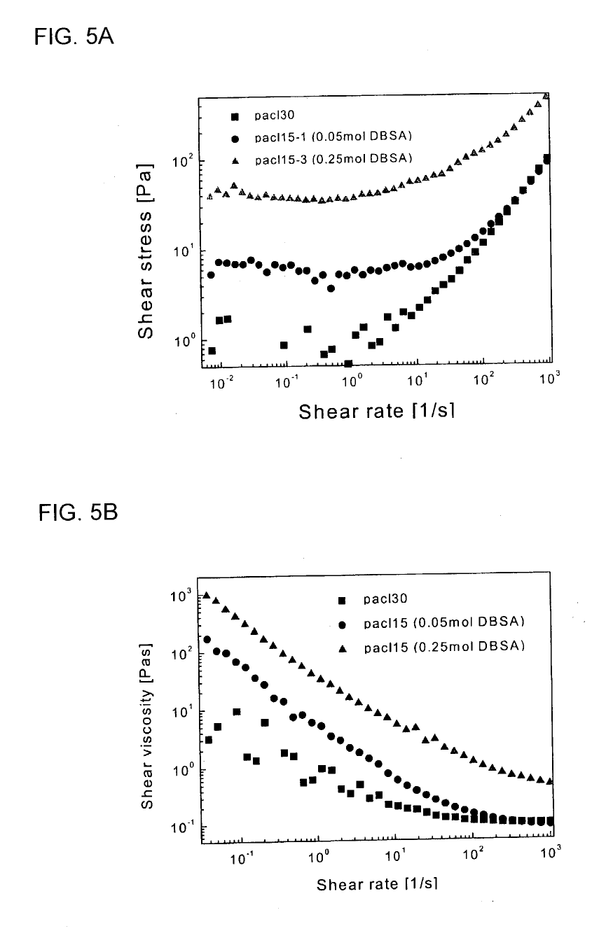

FIGS. 5A and 5B compare the shear stress and shear viscosity curves with three different ER fluids. Among them, the PACL 15-3 system shows the highest ER property. In the case of the fluid containing the particle PACL 30, it seems not to show ER behavior. It is assumed that the optimized condition exists near PACL 15-3.

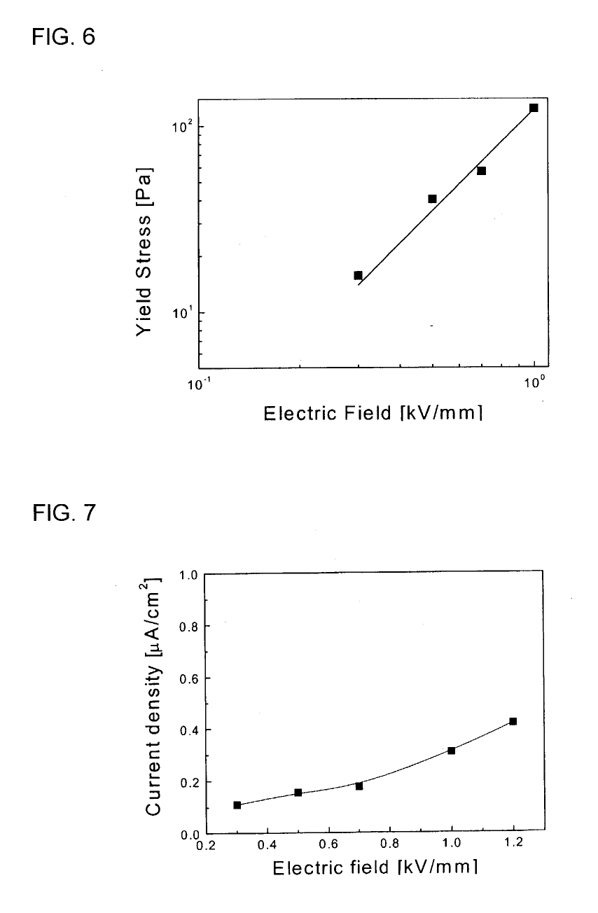

FIG. 6 shows the change of static yield stress (τ_{y}) with different electric fields (E) in a functional form of τ_{y} ∝ E^{1.86}. This result differs from the theoretical prediction that τ_{y} is proportional to E². The difference would be due to several factors, such as particle concentration, shape of the particle, etc.

FIG. 7 shows the change of current density of the PANI-clay nanocomposite ER fluids having 20 wt.% of particle concentration as a function of applied electric field. It can be identified from FIG. 7 that the current density of the ER fluid according to the present invention is in the range of 0.1-0.5 μA/cm² at an electrical field of from 0.3 to 1.2 kV/mm at 25° C. It can be also identified that the current density of the PANI-clay based ER fluids of the present invention increases slightly as the electric field increases. In general, the limitation of current density for commercial ER fluids is about 300 mA/m² at 6 kV/mm. Therefore, the current density of our ER system is much less than the commercial requirement, exhibiting better electrical stability.

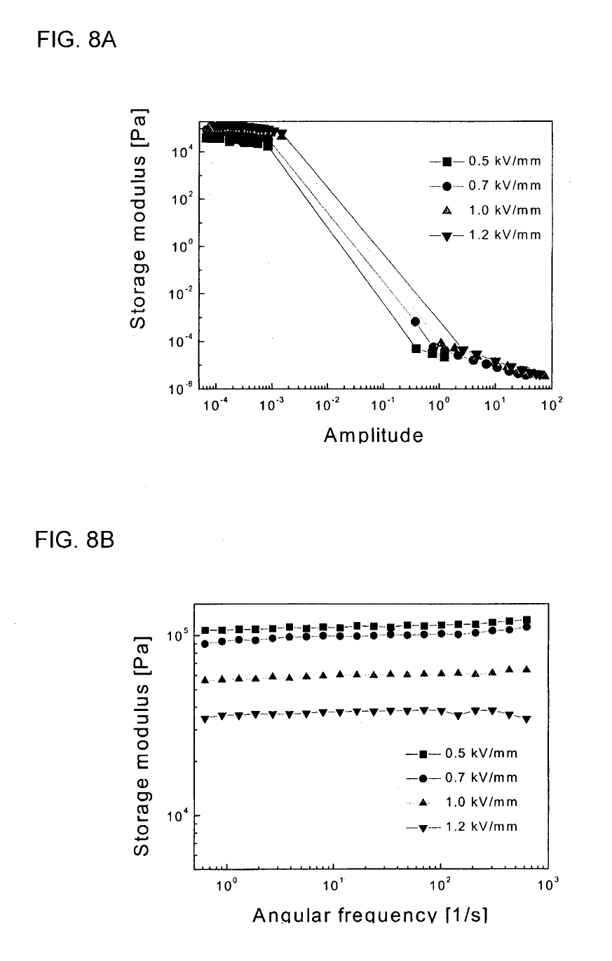

FIG. 8A exhibits the change of storage modulus (G′) with increasing the strain (amplitude) at 2 kV/mm. In order to measure the dynamic properties of PANI-clay nanocomposite-based ER fluid, the present inventors first tried to find a linear region at any amplitudes. However, ER fluid was affected with applied electric field. So, the present inventors choose a proper amplitude region at a chosen electric field.

FIG. 8B shows the linear visco-elastic property with increasing the angular frequency at strain 1.25%. They showed the increment of storage modulus (G′) with electric field and sustained the linearity with angular frequency.

The present invention will now be described in more detail in the following example. However, it is to be understood that this example is merely illustrative and it is not intended to limit the scope of the present invention to the example.

### EXAMPLE 1

The Na⁺-MMT (2.7039 g) in 400 ml of an aqueous medium was prepared and sonicated for 30 minutes using an ultrasonic generator consisting of magneto strictive probe-type transducers (vibrator) operated at a nominal frequency of 28 kHz, equipped with temperature controller. DBSA (0.3 mol) dissolved in 900 ml of distilled water was mixed with a solution of aniline (0.2 mol) in xylene (55.872 g) while stirring for one hour. When the emulsion was formed, the Na⁺-MMT clay and emulsion were mixed in a 4-neck reactor by stirring, while the temperature was kept constant at 25° C. A solution of APS (0.1 mol), an oxidant initiator, in 100 ml of distilled water was then added dropwise into the reactor for one hour.

After stirring at 25° C. for 24 hours, the reaction was terminated by introducing excess amount of acetone into the reaction mixture. Then, the pH of the product was adjusted to 10 by adding either 1M NaOH or HCl aqueous solution. Afterward, PANI-Na⁺-MMT clay nanocomposite particles were obtained with about 30% yield by washing, filtering, drying, milling and sieving the resultant product, sequentially.

Subsequently, 6 g of the obtained PANI-Na⁺-MMT clay nanocomposite particles were dispersed in 24 g of silicone oil having a viscosity of 30 cS to obtain an ER fluid.

What is claimed is:

1. An electro-rheological fluid, comprising polyaniline-clay nanocomposite particles dispersed in a non-conductive medium.

2. The electro-rheological fluid according to claim 1, wherein a content of the polyaniline-clay nanocomposite particles is 15-25% by weight.

3. The electro-rheological fluid according to claim 1, which is an anhydrous system.

4. The electro-rheological fluid according to claim 1, wherein the clay is Na⁺-MMT

5. The electro-rheological fluid according to claim 1, wherein the non-conductive medium is selected from the group consisting of silicone oil, transformer oil, transformer insulating solution, mineral oil, olive oil and mixtures thereof.

6. The electro-rheological fluid according to claim 1, which is thermally stable so as to endure until the temperature reaches to 300° C.

7. The electro-rheological fluid according to claim 1, wherein the polyaniline-clay nanocomposite particles are synthesized by an emulsion polymerization using dodecilbenzenesulfonic acid as an emulsifier for forming emulsion droplets.

8. The electro-rheological fluid according to claim 1, wherein the polyaniline-clay nanocomposite particles have an intercalated structure in which polyaniline is inserted between the layers of the clay.

9. The electro-rheological fluid according to claim 1, wherein the viscosity of the non-conductive medium is 30 cS.

10. The electro-rheological fluid according to claim 1, which shows current density of 0.1-0.5 μA/cm² at an electrical field of from 0.3 to 1.2 kV/mm at 25° C.
